(19) United States
(12) Patent Application Publication
(10) Pub. No.: US 2013/0315642 A1
(43) Pub. Date: Nov. 28, 2013

(54) IMAGE FORMING METHOD, IMAGE FORMING APPARATUS, AND PROCESS CARTRIDGE

(71) Applicants: Hiroshi NAKAI, Kanagawa (JP); Kunio HASEGAWA, Kanagawa (JP); Takuya SEKINE, Kanagawa (JP)

(72) Inventors: Hiroshi NAKAI, Kanagawa (JP); Kunio HASEGAWA, Kanagawa (JP); Takuya SEKINE, Kanagawa (JP)

(73) Assignee: Ricoh Company, Ltd., Tokyo (JP)

(21) Appl. No.: 13/890,410

(22) Filed: May 9, 2013

(30) Foreign Application Priority Data
May 23, 2012 (JP) 2012-117844

(51) Int. Cl. G03G 21/00

(52) U.S. Cl. CPC G03G 21/0094
USPC 399/346

(57) ABSTRACT

An image forming method including forming a latent electrostatic image borne on an image bearing member, developing the latent electrostatic image with a development agent accommodated in a development unit, the development agent containing toner, applying or attaching a protective agent to the surface of the image bearing member by a protective agent supplying device including a foam roller, and supplying particulates having a true spherical form between the surface of the image bearing member and a surface of the foam roller.

### CROSS-REFERENCE TO RELATED APPLICATIONS

This patent application is based on and claims priority pursuant to 35 U.S.C. §119 to Japanese Patent Application No. 2012-117844, filed on May 23, 2012, in the Japan Patent Office, the entire disclosure of which is hereby incorporated by reference herein.

### BACKGROUND

1. Technical Field

The present invention relates to an image forming method, an image forming apparatus, and a process cartridge.

2. Background Art

In conventional image forming by electrophotography, visible images are generated by attaching charged toner particles to a latent electrostatic image formed by electrostatic charges on an image bearing member made of a photoconductive material.

The visible image formed by the toner is transferred to a medium substrate such as paper and fixed thereon by heat, pressure, solvent, air, etc. to output an image.

Image forming apparatuses employing electrophotography typically possesses a belt or drum image bearing member (typically, photoreceptor). While the image bearing member is rotated, it is firstly charged and then exposed to a pattern of activating electromagnetic radiation, such as beams of light, to form a latent electrostatic image on the surface of the image bearing member.

The latent electrostatic image is rendered visible by a developing device followed by transfer thereof to a transfer medium.

Toner compositions that have not been transferred onto the transfer medium remain on the image bearing member after the toner image transfer.

If these remnants are transferred and subjected to the charging step, the image bearing member may not be uniformly charged. Conventionally, after the image transfer, such remnants are removed from the surface of the image bearing member in a cleaning process to make the surface clean and ready for the next image forming cycling.

This imaging process may be repeated many times with the reusable image bearing member. Accordingly, the surface of the image bearing member is subjected to various physical stresses and electric stresses in each of the development, transfer, cleaning step, etc.

As a consequence, this repetitive cycling leads to gradual change (deterioration) of the exposed surface.

In particular, due to the friction between the surface of the image bearing member and a cleaning member in the cleaning step, the surface of the image bearing member is abraded and the service life of the cleaning member is shortened.

At the same time, image forming apparatuses and elements for use therein having long useful lives are attractive to the market in terms of the reduction of running cost and the protection of the environment by reducing the amount of waste.

Increasingly, elements other than the image bearing member also have been demanded to have long working lives, which gives rise to an issue of reducing the stress in the cleaning step.

Additionally, both a contact charging system and a proximity charging system have come into widespread use reflecting the demand for a compact inexpensive machine.

In most cases, the proximity charging system employs an AC superimposing charging system in which an alternate current (AC) component is superimposed on a direct current (DC) component to achieve uniform charging.

The proximity charging system utilizing the AC-component superimposition is significantly advantageous in manufacturing a compact machine and improving the quality of print. Additionally, since the charging member and the image bearing member are not in contact with each other while maintaining uniform charging, the deterioration of the charging member is suppressed.

However, non-uniform contact between a charger and the surface of the image bearing member in the contact charging system or a gap variance therebetween in the proximity charging system makes it difficult to charge the surface of the image bearing member uniformly.

When it comes to a case in which the image bearing member is an organic photoconductor (OPC), it is found that the energy of the AC superimposition charging severs resin chains of the surface of the image bearing member and degrades the mechanical robustness thereof, which accelerates the abrasion of the image bearing member markedly.

Moreover, the AC superimposition charging activates the surface of the image bearing member, thereby increasing the attachability of the surface of the image bearing member and the toner, which is disadvantageous in terms of cleanability.

Furthermore, to improve the print quality, smaller toner particles having sphere-like form have been tried and used, which creates more and more difficult conditions in light of the cleaning.

In attempts to solve this issue by reducing the friction force between an image bearing member and a cleaning member to protect both of them, there are disclosed many lubricants (protecting agents) and methods of supplying lubricant components and forming layers thereof.

For example, JP-S51-22380-B discloses a method of forming a lubricant film layer on the surface of the image bearing member by supplying a solid lubricant containing zinc stearate as the main component to prolong the useful life of the image bearing member and the cleaning blade.

JP-2006-350240-A discloses that, by supplying various lubricants to which boron nitride, one of inorganic lubricants, is added to a solid lubricant mainly composed of zinc stearate to the surface of an image bearing member, the improved lubricity is maintained even when the surface of the image bearing member is under electric stress in the charging step because a lubricant film is formed all over the surface of the image bearing member.

JP-2007-65100-A discloses a lubricant supplier (coating member) serving as an applicator mechanism of a lubricant, which includes a rotating brushing member that slidably contacts an image bearing member, a solid lubricant that contacts the rotating brushing member, a pressure mechanism that biases the solid lubricant towards the rotating brushing member, etc.

The lubricant is gradually scraped from the solid lubricant as the rotating brushing member rotates in a particular direction. The lubricant scraped off from the rotating brushing member is coated on (supplied to) the surface of the image bearing member.

However, in the configuration in which a spring is pressed against the brushing member, as the solid lubricant is scraped, the spring extends and the pressure thereof naturally weakens.

As a consequence, the amount of scraped solid lubricant decreases so that the amount of the solid lubricant supplied to the image bearing member or the intermediate transfer belt decreases. Consequently, the image bearing member or the intermediate transfer belt are not sufficiently protected.

In an attempt to solve this problem, JP-2007-293240-A, etc. discloses a configuration in which a movable pressure member provided to the member holding the solid lubricant is pressed by the spring member to sustain the pressure over time.

JP-2009-150986-A discloses a configuration in which, by using a protective agent applicator formed of a foamed layer, a uniform solid lubricant film is formed on the surface of the image bearing member in a relatively small consumption amount.

However, if the protective agent supplying roller illustrated in JP-2007-65100-A mentioned above is used to execute the method of supplying the protective agent specified in, for example, indicated by JP-S51-22380-B and JP-2006-350240-A mentioned above, powder of the protective agent slidably abraded from the protective agent block scatters in air in a large amount, which is a waste of the protective agent.

Moreover, the brush fiber is significantly damaged over time.

Therefore, even if the protective agent pressure mechanism that can maintain the same pressure over time as disclosed in JP-2007-293240-A mentioned above is used, the consumed amount of the protective agent varies over time, which makes it impossible to supply the protective agent stably over an extended period of time.

In particular, when the protective agent block is prepared by compression-molding, the degree of the variation worsens.

To the contrary, by using the protective agent application roller formed of the foamed layer disclosed in JP-2009-150986-A mentioned above, the protective agent scarcely scatters over an extended period of time even if it is slidably abraded.

Moreover, a solid lubricant film is uniformly formed on the surface of an image bearing member with a relatively small consumed amount by constantly supplying the protective agent over an extended period of time with no concern about the damage or deterioration of the brush fiber.

In addition, the roller can be manufactured more economically than the brush, which contributes to the cost reduction of the unit.

However, the foaming elastic roller having the configuration disclosed in JP-2009-150986-A mentioned above has a larger contact area with the image bearing member than the brush.

In the case of the brush roller, brush fiber bends at the contact area with the image bearing member, which reduces the stress at the nipping portion but the foaming elastic roller has a small stress relieving ability.

Therefore, the mechanical burden required to drive the elastic roller is extremely large, which cause breakage of the driving member or damage to the image bearing member.

### SUMMARY

The present invention provides an image forming method including forming a latent electrostatic image borne on an image bearing member, developing the latent electrostatic image with a development agent containing toner and accommodated in a development unit, applying a protective agent to the surface of the image bearing member by a protective agent supplying device including a foam roller, and supplying particulates having a true spherical form between the surface of the image bearing member and a surface of the foam roller.

### BRIEF DESCRIPTION OF THE DRAWINGS

Various other objects, features and attendant advantages of the present invention will be more fully appreciated as the same become better understood from the detailed description when considered in connection with the accompanying drawings, in which like reference characters designate like corresponding parts throughout and wherein:

FIG. 1 is a schematic diagram illustrating an example of the process cartridge for use in the image forming apparatus of the present disclosure;

FIGS. 2A and 2B are diagrams illustrating an example of the method of measuring the number of cells in the foam layer in a foam roller; and

FIG. 3 is a schematic diagram illustrating an embodiment of the image forming apparatus of the present disclosure.

### DETAILED DESCRIPTION

Embodiments of the present disclosure are described with reference to the accompanying drawings.

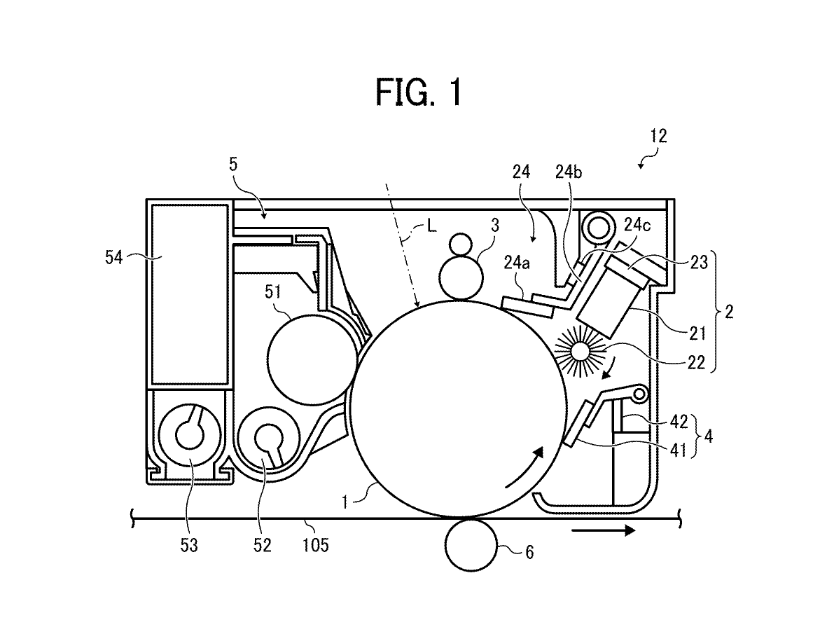

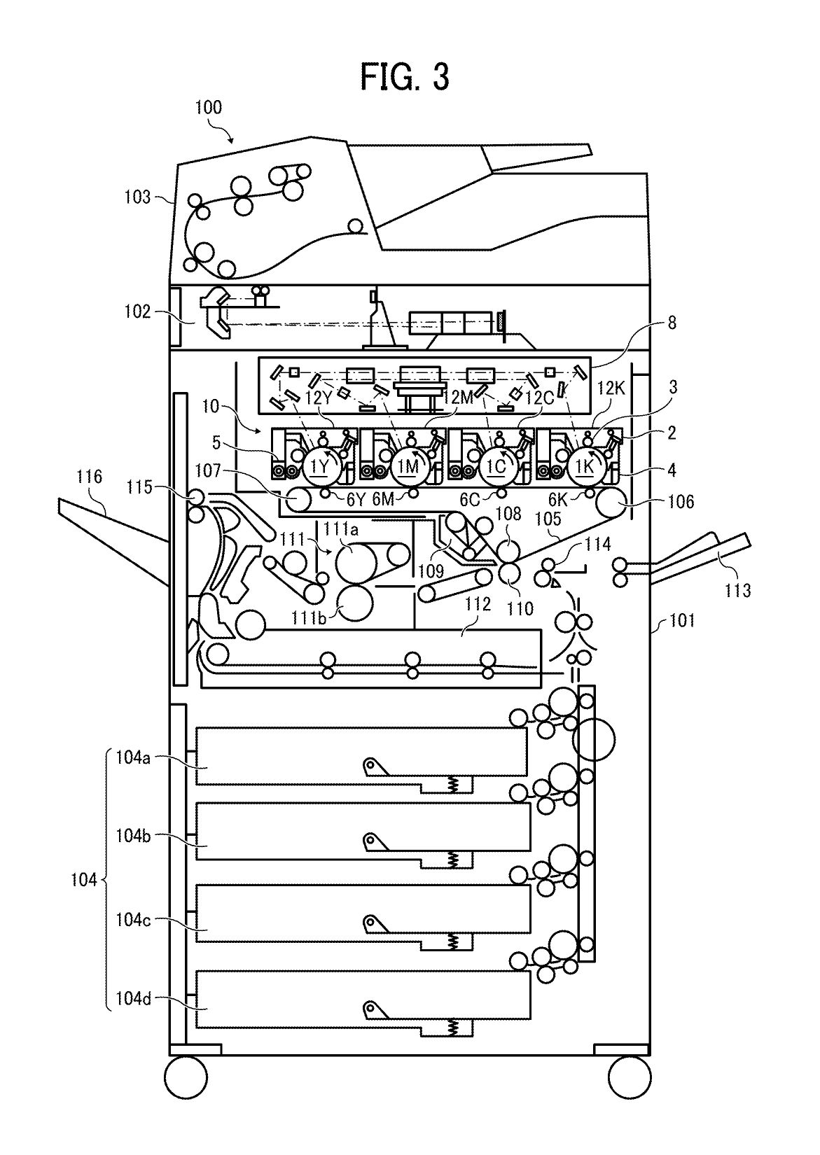

First embodiment is described with reference to FIGS. 1 and 3.

FIG. 1 is a schematic cross-sectional view illustrating an example of the structure in which the image forming method of the present disclosure is applied to a process cartridge 12.

A protective agent supplying device 2 provided facing a drum photoreceptor 1 serving as an image bearing member includes an image bearing member protective agent 21 having a block-like shape, a protective agent supplying member 22 formed of a foam roller, a pressure imparting mechanism 23 to bias the image bearing member protective agent 21 to the protective agent supplying member 22, and a protection layer forming mechanism 24.

The image bearing member protective agent (hereinafter referred to as “protective agent”) is brought into contact with the protective agent supplying member 22 from the pressure imparting mechanism 23. The protective agent supplying member 22 rotates with a different linear speed from that of the drum photoreceptor 1 and slidably rubs the drum photoreceptor 1 to supply the protective agent held on the surface of the protective agent supplying member to the surface of the drum photoreceptor 1.

In addition, the drum photoreceptor 1 has a surface on which partially degraded protective agent and toner components remain after the transfer process but the surface is cleared of the remnants thereof by a cleaning member 41.

In FIG. 1, the cleaning member 41 is brought into contact with an angle in a counter manner (leading type).

After the remaining toner and degraded toner on the surface of the drum photoreceptor 1 are removed by a cleaner 4, the protective agent 21 is supplied from the protective agent supply member 22 to the surface of the drum photoreceptor 1 to form a protection layer having a film-like form by the protection layer forming mechanism 24.

The protection layer forming mechanism 24 includes a blade 24a, a blade supporting member 24b, and a biasing member 24c.

The blade 24a contacts the drum photoreceptor 1 in the trailing direction thereof.

The blade supporting member 24b supports the blade 24a.

The biasing member 24c biases the blade 24a and the blade supporting member 24b toward the drum photoreceptor 1.

A coil spring, a member having a rubber resilience, board spring, and any other elastic member can be suitably used as the 24c.

After the drum photoreceptor 1 on which the protection layer is formed is charged, a latent electrostatic image is formed thereon by exposure to beams of light L, etc. and developed by a development unit 5 serving as a development device to obtain a visible image, which is then transferred to an intermediate transfer body 105 by a transfer roller 6, etc. provided outside the process cartridge.

The development unit 5 includes a development roller 51, transfer screws 52 and 53 to circulate the development agent while stirring and transferring the development agent, and a preset case 54.

The foam roller serving as the protective agent supplying member is formed by, for example, as follows: Preliminarily form a polyurethane foam block serving as an elastic layer from polyurethane foam raw materials; cut it to a suitable size and shape followed by surface-grinding: insert a core material thereinto; Thereafter, contact the grinding blade to the block and move the blade in parallel to the axis direction of the polyurethane foam while rotating the polyurethane foam to cut to a given sponge thickness (referred to as a traverse cutting method): Alternatively, inject polyurethane foam raw materials into a foam roller mold containing the core material followed by foaming and curing.

The polyurethane foam can be manufactured by known methods in the art. Material to which a helping agent such as polyol, poolyisocyanate, a catalyst, a foaming agent, and a foam controlling agent is added is used as the polyurethane foam raw material. Normally, the components except for polyisocyanate are preliminarily mixed and admixed with the polyisocyanate component just before molding.

Polyether polyol is preferable as the polyol component in terms of easiness of controlling workability, hardness of a polyurethane foam layer, etc. but the polyol component is not limited thereto. Any known polyether polyol is suitably usable but is not limited thereto.

In general, it is suitable to select polyether polyol such as polyether polyether polyol, polyester polyether polyol, polymer polyether polyol, which is for use in manufacturing soft polyurethane foam. These can be used alone or in combination.

The mold property is said to be good when using polyether polyether polyol in which ethylene oxide is bonded at the end in an amount of at least 5 percent by mole.

Any known polyisocyanate can be used for manufacturing a polyurethane foam layer.

Specific examples thereof include, but are not limited to, 2,4- and 2,6-tolylene diisocyanate (TDI), tolidine diisocyanate (TOM), naphthylene diisocyanate (NDI), xylylene diisocyanate (XDI), 4,4′-diphenyl methane diisocyanate (MDI), carbodiimide-modified methylene diphenyl diisocyanate (MDI), polymethylene polyphenyl polyisocyanate, and polymeric polyisocyanate. These can be used alone or in combination.

Any known catalyst that is used in urethanification reaction is selected as the catalyst to manufacture a polyurethane foam layer. Specific examples thereof include, but are not limited to, amine-based catalysts such as tryethylene diamine, dimethyl ethanol amine, and bis (dimethylamino)ethylether, such as organic metal-based catalysts such as dioctyl tin and distearyl tin dibutylate, and modified catalysts thereof.

Also, a reactive catalyst such as dimethyl amino ethanol having an active hydrogen is suitable.

Cell wall width, aperture cell diameter, hardness, draft quantity, etc. of the polyurethane foam layer can be controlled by the selection and the quantity of the catalyst.

Any foam controlling agent for use in manufacturing polyurethane foam can be used to manufacture the polyurethane foam layer. Silicone-based surface active agent is preferably used.

There is no specific limit to the foaming agent for use in manufacturing the polyurethane foam layer.

Any known foaming agent such as water, material having a low boiling point, and gas can be used alone or in combination.

It is preferable to use water in light of the impact on the environment.

Other foaming agents can be used in combination.

By changing the quantity and the conditions of a foaming agent, it is possible to control the cell wall width, aperture cell diameter, hardness, draft quantity etc. of the polyurethane foam layer.

It is possible to blend a cross-linker, a foam-breaker, etc. with the raw material for the polyurethane foam layer to control the independent foaming property and continuous foaming property of the cells of the polyurethane foam layer or add a conducting agent, an antistatic agent, etc. to impart desired conductivity.

Specific examples of the cross-linkers include, but are not limited to, known agents such as triethanol amine and dietanol amine.

As other additives, with regard to conducting agents, flame retardants, viscosity reducers, pigments, stabilizers, colorants, antioxidants, ultraviolet absorbers, antioxidant agents, oxidation inhibitors, etc., known products can be blended, if desired.

There is no specific limit to the number of cells and hardness of the entire foam layer in the foam roller. In terms of supplying relatively small and uniform protective agent particles to an image bearing member, the number of cells is preferably from 20 cells/25 mm to 300 cells/25 mm and particularly preferably from 60 cells/25 mm to 300 cells/25 m.

The hardness is preferably from 40 N to 430 N and particularly preferably from 40 N to 300 N.

When using a molded block as the protective agent, the particle diameter of a protective agent supplied to the surface of an image bearing member can be controlled by the number of cells and hardness of the foam layer. For example, the particle diameter of the protective agent decreases as the number of cells increases or the hardness decreases.

However, the ability of a roller scraping the protective agent block is weak, so that the scraping amount of the protective agent block decreases.

The average of the values measured by the following method is used as the number of cell in the foam layer.

In the surface of the foam layer, three points are arbitrarily selected at both ends and the center in the axis direction.

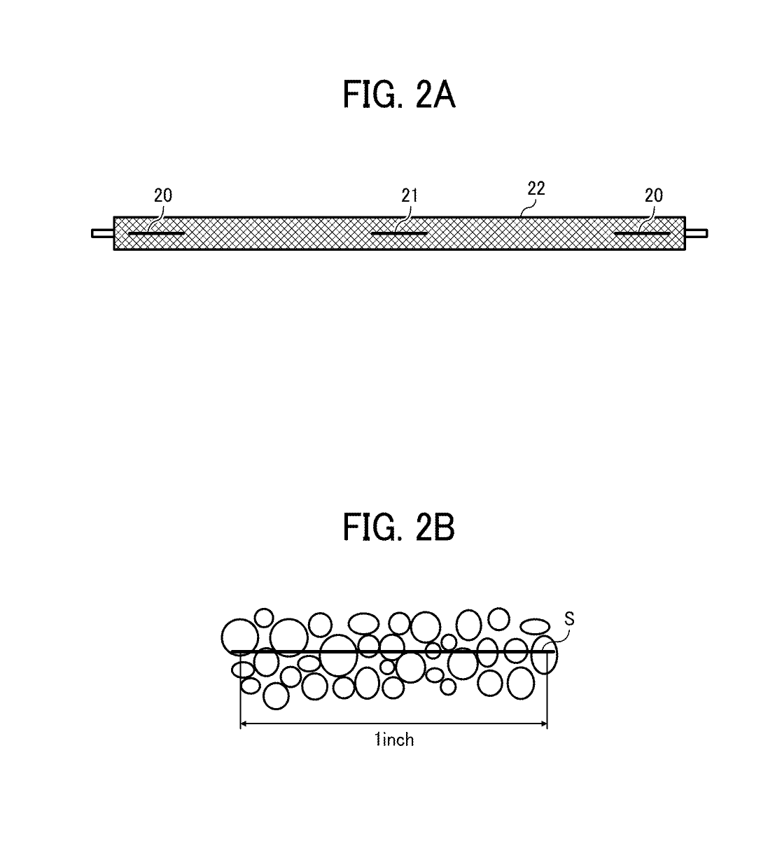

In FIG. 2A, a reference numeral 20 represents the measured points at both ends and, a reference numeral 21, at the center.

Next, two more measured points are selected along the circumference direction for each measured points, which makes 9 measured points in total.

Then, using a microscope, photo images at respective measured points are observed. As described in FIG. 2B, draw a line S corresponding to the length of 1 inch (about 25 mm) at the center of the photo image and count the number of cells on the line S.

Any cell that contacts (even if barely contacts) the line S is counted as one. For example, in the example illustrated in FIG. 2B, the number of cells is 12.

The hardness of a foam layer is the average of values measured at arbitrarily selected points on the foam layer based on JIS K 6400.

The core material of the foam roller of the embodiment is for example, a cylinder made of metal such as iron, aluminum, or stainless steel, or non-metal such as a resin but is not limited thereto An adhesive layer can be preliminarily provided on the core material.

In the manufacturing method in which a mold of the foam roller containing the core material mentioned above is used, it is preferable to provide a releasing agent made of a fluorine-containing resin coating agent, a releasing agent, etc. on the inside surface of the mold. This does not require a complicate processing so that a polyurethane foam layer having a suitable aperture property is easily formed.

In a case in which a foam roller is used as a protective agent supplying member as in this embodiment, it is good with regard to supply of the protective agent. However, as described above, the mechanical load required to drive the roller is extremely heavy, which may cause breakdown of the driving member or damage to the image bearing member.

This is an inevitable side-effect stemming from the idea of uniformly supplying a lubricant to the surface of an image bearing member by increasing the contact area between the surface and the roller.

In attempts to solve this side-effect by changing the roller properties, such as decreasing the number of cells thereof and decreasing the amount of the foam biting into an image bearing member, the uniformity of the supply of the protective agent is sacrificed.

To solve such problems, in the embodiments, particulates having a true spherical form are supplied from the development unit 5.

The development unit 5 is filled with a two-component development agent containing toner and toner carrier or a single-component development agent containing only toner. In the embodiment, either of the development agents is suitably usable.

Any known toner or toner carrier can be used.

In addition to the development agent, the development unit 5 accommodates at least one kind of particulates having a true spherical form.

Any inorganic particulate or organic particulate that has a true spherical form can be used.

Specific examples of the organic particulates include, but are not limited to, powders of fluorine-containing resins such as polytetrafluoro ethylene, silicone resin powder, and a-carbon powder.

Specific examples of the inorganic particulates include, but are not limited to, metal oxides such as silica, tin oxide, zinc oxide, titanium oxide, alumina, zirconium oxide, indium oxide, antimony oxide, bismuth oxide, calcium oxide, tin oxide doped with antimony, indium oxide doped with tin, and metal salts of titanic acid such as potassium titanate and strontium titanate.

In the embodiment, the true sperical form has an average sphericity of from 0.85 to 1.00, which is obtained as follows:

The average sphericity can be measured as follows by taking in particle images taken by a stereoscopic microscope, a scanning electron microscope, a transmission electron microscope, etc. into an image analyzer (e.g., Luzex AP, manufactured by Nireco Corporation).

Measure the projected area (A) and the perimeter (L) of the particle from the image.

The sphericity is represented by A/B, where B represents the area of the true circle having the perimeter L.

Assume a true circle having the perimeter L of a sample particle and if its radius is represented by “r”, B=π×(L/2π)² because L is 2πr and B=πr². The sphericity of each particle can be calculated from the relation: A/B=A×4π/L². Calculate the sphericity for 100 particles and determine the average thereof as the average sphericity.

The average particle diameter of the particulate having a true spherical form preferably ranges from 0.3 μm to 3 μm and more preferably from 0.5 μm to 2 μm. When the average particle diameter is too small, the mechanical load during roller driving is not significantly reduced.

When the average particle diameter is too large, the surface of an image bearing member is easily damaged.

When the average particle diameter is within the range, the mechanical load is particularly and significant reduced, as is the contamination of the image bearing member.

The average particle diameter is the average of the diameter of the true circle obtained when calculating the average sphericity, that is, the average of the diameter 2r of the true circle of each of arbitrarily selected 100 sample particles when assuming the true circle has the same perimeter as that of each of arbitrarily selected 100 sample particles.

The reason why such particles having true spherical forms are good is inferred that if such particles are present between a foam roller and an image bearing member, the friction is reduced because of the rolling action of the particulates.

When the particles are of irregular shapes, they tend to abrade the surface of an image bearing member, which is disadvantageous in terms of reducing the mechanical load and not preferable because wear of the surface of the image bearing member is accelerated.

Although it is possible to provide an independent supplying mechanism to provide particulates having true spherical forms contained in a development agent, it is preferable to supply the particulates and toner together to a development unit when supplying the toner by preliminarily mixing the particulates with the toner in light of space-saving and simplicity of the supplying mechanism.

With regard to the addition amount of the particulate having a true spherical forms, the preferable range changes depending on the kinds of materials.

The lower limit is required to be set in order not to have an adverse impact on the reduction of the torque during the roller driving and the upper limit is required to have no adverse impact with regard to the damage or adherence to the surface of the image bearing member or the chargeability or the fluidity of the development agent.

In general, the addition amount ranges from 0.01% to 10% of the amount of toner. There are many documents including JP-2002-214825-A that discloses usage of particulates such as silica having a true spherical form as external additives for toner.

Unlike those, the particulates having true spherical form in the embodiment is not an external additive because it is present away from toner.

If the particulate having a true spherical form is externally added to toner as in the conventional manner, for example, in a case in which documents having no or few images are continuously printed, no or little of the particulate having a true spherical form is supplied to the surface of an image bearing member because the particulate having a true spherical form is supplied together with the toner.

Consequently, the torque is not reduced. That is, the torque reduction greatly depends on the state of print. To the contrary, in the case of the development agent in which the particulate having a true spherical form is not externally added but mixed as in the embodiment, the particulate having a true spherical form is supplied to the surface of the image bearing member by centrifugal when the development roller rotates because the particulate having a true spherical form is distantly-positioned from the toner.

Even if documents having no or few images are continuously printed, a certain amount of the particulate having a true spherical form is supplied, thereby reducing the torque constantly irrespective of the state of the print.

The embodiment is separated from the conventional technology in that the particulate having a true spherical form is not externally added to the toner particle but preferably present away therefrom.

In addition, in the case in which the particulates distant from the toner are used in combination with a brushing member typically serving as a protective agent applicator, the particulates tend to adhere onto the image bearing member even if particulate having a true spherical forms having weak attachment force is used.

However, since the foam roller has a large contact area with the image bearing member, a large force is applied to the particulates so that they easily roll on the surface of the image bearing member and are not easily attached thereto.

That is, to roll a particulate having a true spherical form on a plane, it is necessary to apply a force horizontally as well as a suitable force vertically in the same manner as when you roll a ball while pressing it with a hand. Since the foam roller has many contact surfaces with the image bearing member, the pressure at the contact surface is moderately distributed locally so that the particulate is inferred to easily roll on a member like the foam roller.

On the other hand, if the contact portion is a point or line as in the case of a brush, the contact area is so small that the pressure at the contact portion is extremely high and the force to press the member against the image bearing member is inferred to be excessively strong.

In addition, since each fiber of a brush violently moves when the brush contacts an image bearing member, the brush is thought to have function of hitting the particulates onto the image bearing member, which inferentially increases the attachment force thereto.

In the embodiment of the present disclosure, the mechanical stress is reduced without the side effect by the combinational use of a foam roller having a large contact area with an image bearing member and the particulate having a true spherical form having a great rolling action.

Next, the protective agent for use in the embodiment is described.

In the embodiment, usage of a protective agent to protect an image bearing member from the various stresses as described above is a precondition.

As to the protective agent, materials are preferable which uniformly and quickly extend on the surface of an image bearing member to protect it and impart lubricity to protect a blade.

Specific examples thereof include, but are not limited to, inorganic lubricants, aliphatic acid metal salts, waxes, oils, and fluorine resins.

In the embodiment, it is preferable to use an aliphatic acid metal salt as the protective agent and more preferable to use a mixture of an aliphatic acid metal salt and an inorganic lubricant.

Either of protective agent powder and molded protective agent is usable.

In the embodiment, a protective agent block is preferable in terms that the amount can be easily controlled and a compact machine is available.

As to the molding, known methods can be used such as a melt molding method in which materials are melted and poured into a mold followed by cooling and solidification and a compression molding in which powder materials are compressed to obtain a mold product. In the embodiment of the present disclosure, the compression molding is preferable in terms that the protective agent is ground by a weak force and easily supplied to the surface of an image bearing member.

Specific examples of the aliphatic acid metal salts include, but are not limited to, barium stearate, lead stearate, iron stearate, nickel stearate, cobalt stearate, copper stearate, strontium stearate, calcium stearate, cadmium stearate, magnesium stearate, zinc stearate, zinc oleate, magnesium oleate, iron oleate, cobalt oleate, copper oleate, lead oleate, manganese oleate, zinc palmitate, lead palmitate, magnesium palmitate, aluminum palmitate, calcium palmitate, lead caproate, zinc caproate, zinc linolenate, cobalt linolenate, calcium linolenate, zinc ricinoleate, cadmium ricinoleate, barium laurate, lithium laurate, calcium laurate, and zinc laurate. Mixtures thereof are also usable.

Among these, it is preferable to use zinc stearate as the main component of the protective agent because it has a particularly excellent filming property on the surface of an image bearing member. The main component means that it is present in amount of 50 percent by weight or more of the total amount of the protective agent.

Although zinc stearate is excellent about uniform filming property, it has a problem about the cleanability. In a conventional imaging process, a blade cleaning system is employed as a device to remove residual toner remaining on an image bearing member but if zinc stearate is used, the toner tends to slip through the blade when a charging hazard is added. When the toner has slipped through the cleaning blade, the toner appears directly on a print or accelerates contamination of a charger. This slip-through of the toner increases as the toner particles become small or the charging hazard increases. At the same time, as the amount of toner that has slipped through the cleaning blade increases, the cleaning blade is abraded, thereby reducing the working life of the imaging device.

Consequently, it is preferable to use a mixture of an aliphatic acid metal salt and an inorganic lubricant in the embodiment.

The inorganic lubricant in the embodiment means an inorganic compound that cleaves itself and lubricates or slips from inside.

Specific examples thereof include, but are not limited to, talc, mica, boron nitride, molybdenum disulfide, tungsten disulfide, kaolin, smectite, hydrotalcite compounds, calcium fluoride, graphite, plate-like alumina, sericite, and synthesized mica.

Among these, in boron nitride, hexagon network layers in each of which atoms are firmly interlocked are overlapped with a wide gap with only a weak force of van der Waals attraction between the layers so that boron nitride easily cleaves and lubricates.

Thus, boron nitride is most preferably used in the embodiment. These inorganic lubricants may be surface-treated in order to impart hydrophobicity.

Since the image bearing member protective agent supplied to the surface of the image bearing member may not form a sufficient protection layer depending on the selection of the material, the protective agent on the image bearing member is regulated by a protective agent layer forming mechanism having a blade-like member to have a thin and uniform protection layer.

The image bearing member on which the protection layer is formed is subject to charging by discharging at a minute gap between the image bearing member and a charging roller 3 provided in contact with or in the proximity of the image bearing member. A DC voltage or a voltage in which an AC voltage is superimposed on a DC voltage generated by a high voltage power supply is applied to the charging roller 3. Due to this charging, part of the protection layer is decomposed or oxidized under the electric stress and in addition, corona products are produced and attached to the surface of the protection layer.

The degraded protective agent is removed together with other components such as toner remaining on the image bearing member by a typical cleaning mechanism. The protection layer forming member described above can be used as such a cleaning mechanism.

However, separating the function of removing the residual on the image bearing member and the function of forming a protection layer thereon is preferred because the abrasion status of suitable members for respective functions is different in some cases.

Therefore, as illustrated in FIG. 1, a cleaning mechanism 4 formed of a cleaner 41 and a cleaning pressure mechanism 42 is preferably provided on the upstream of the protective agent supply device 2 relative to the rotation direction of the image bearing member.

There is no specific limit to the material of the blade for use in the protection layer forming mechanism.

Specific examples thereof include, but are not limited to, known materials for a cleaning blade such as urethane rubber, hydrine rubber, silicone rubber, fluorine-containing rubber. These can be blended for use.

In addition, the contact portion of these rubber blades with the image bearing member can be subject to coating or impregnation treatment using a material having a low friction coefficient. In addition, fillers such as organic fillers or inorganic fillers can be dispersed in the elastic body to adjust the hardness thereof.

These cleaning blades are fixed onto a blade support by an arbitrary method using, for example, adhesion or attachment such that the front end of the blade is directly brought into contact with and pressed against the surface of the image bearing member. The thickness of the blade is not necessarily unambiguously regulated considering the balance between the blade and the applied pressure but is preferably from about 0.5 mm to about 5 mm and more preferably from about 1 mm to about 3 mm.

In addition, the length, i.e., free length, of the extension blade having flexibility which protrudes from the support is also not necessarily unambiguously regulated considering the balance between the free length and the applied pressure but is preferably from about 1 mm to about 15 mm and more preferably from about 2 mm to about 10 mm.

As other structures of the blade for use in forming a protection layer, a layer of resin, rubber, elastomer, etc. is formed on the surface of an elastic metal blade such as a spring board by coating, dipping, etc., via an optional coupling agent or primer component, and optionally thermally cured. The formed layer can be subject to surface grinding treatment, if desired.

The thickness of the elastic metal blade is preferably from about 0.05 mm to about 3 mm and more preferably from about 0.1 mm to about 1 mm.

The elastic metal blade can be subject to treatment such as bending work to arrange the blade significantly parallel to the spindle after assembly to prevent distortion of the blade.

Material such as fluorine resins such as PFA, PTFE, FEP, and PVdF, fluorine-containing rubber, and silicone-based elastomers such as methyiphenyl silicone elastomers can be used with an optional bulking agent to form the surface layer.

The pressure applied to the image bearing member by the protection layer forming mechanism is sufficient if the protective agent thereon is extended to form a uniform protection layer. The linear pressure is preferably from 5 gf/cm to 80 gf/cm and more preferably from 10 gf/cm to 60 gf/cm.

FIG. 3 is a cross sectional view illustrating an example of a tandem type intermediate transfer color photocopier 100 serving as an image forming apparatus that executes the image forming method of the embodiment.

The color photocopier 100 includes a main part 101, a scanner 102 provided on the main part 101, and an automatic document feeder (ADF) 103 provided on the scanner 102. Below the main part 101, there is provided a feeding unit 104 having multiple sheet feeding cassettes 104a, 104b, 104c, and 104d.

At the significant center of the main part 101, there is provided an intermediate transfer belt 105 having an endless form serving as an intermediate transfer element. The intermediate transfer belt 105 is supported by being stretched around multiple supporting rollers 106, 107, 108, etc. and rotationally driven clockwise by a driving source.

Around the supporting roller 108, there is provided an intermediate transfer element cleaner 109 that removes residual toner remaining on the intermediate transfer belt 105 after secondary transfer.

On the intermediate transfer belt 105 stretched between the supporting roller 106 and the supporting roller 107, there are provided process cartridges 12Y, 12M, 12C, and 12K side by side serving as four image forming devices of yellow (Y), magenta (M), cyan (C), and black (K), along the transfer direction of the intermediate transfer belt 105 to constitute a tandem type image forming unit 10. This color sequence is a mere example and the sequence is not limited thereto.

There is provided an irradiator 8 above the tandem image forming unit 10. A secondary transfer roller 110 serving as a transfer device is provided on the opposite side of the supporting roller 108 with the intermediate transfer belt 105 therebetween.

An image on the intermediate transfer belt 105 is transferred by a secondary transfer roller 110 to a recording medium (typically sheet) fed by the feeding unit 104.

A fixing device 111 to fix the transferred image on the recording medium is provided on the left-hand side of the secondary transfer roller 110.

The fixing device 111 has a structure in which a pressure roller 111b is pressed against a fixing belt 111a having an endless form.

A sheet reversing device 112 to reverse the sheet of which images are printed on both sides is provided substantially parallel to the tandem image forming unit 10.

A series of the image forming processes are described using a negative-positive process.

A drum photoreceptor 1 (1Y, 1M, 1C, 1K) typically represented by an organic photoconductor (OPC) having an organic photoconductive layer is discharged by a discharging lamp, etc. and uniformly charged with a negative polarity by a charging roller 3 serving as a charging device.

When the photoreceptor drum 1 is charged by the charging roller 3, a voltage applicator applies a charging bias having a suitable DC voltage or voltage in which an AC voltage is overlapped with the suitable DC voltage to the charging member such that the photoreceptor drum 1 is charged to a desired voltage.

A latent image is formed on the charged drum photoreceptor 1 by a laser beam emitted from the irradiator 8 including, for example, a laser beam system.

The absolute voltage at an irradiated portion is lower than the absolute voltage at a non-irradiated portion.

The laser beam is emitted from a semiconductor laser and reaches the surface of the drum photoreceptor 1 through a polygon mirror having a polygonal column that is rotating at a high speed to scan the surface in the rotation axis direction of the drum photoreceptor 1.

The thus-formed latent image is developed by toner particles or a mixture of toner particles and carrier particles supplied onto the development sleeve of the development roller 51 in the development unit 5 to form a visible toner image.

When the latent image is developed, a voltage applicator applies a development bias of a suitable DC voltage or AC voltage in which an AC voltage is superimposed with the suitable DC voltage to the development sleeve.

The toner image formed on the drum photoreceptor 1 corresponding to each color is superimposed on the intermediate transfer belt 105 by a transfer roller 6 (6Y, 6M, 6C, 6K) to form a toner image (color image) and transferred onto a transfer medium (sheet) such as paper fed from the feeding unit 104 or a manual tray 113 once by the secondary transfer roller 110.

The sheet sent out from one of the sheet feeding units selected from the feeding unit 104 or the manual tray 113 is temporarily stopped at a pair of registration rollers 114 to correct skew of the sheet. The pair of the registration rollers 114 is rotated in synchronization with the synthesized color image on the intermediate transfer belt 105 to send the sheet between the intermediate transfer belt 105 and the secondary transfer roller 110, where the color image is transferred on the sheet.

It is preferable to apply a voltage having a polarity reversed to that of the toner charging to the transfer roller 6 as a transfer bias.

In addition, the toner particles remaining on the photoreceptor drum 1 are retrieved into a toner collecting room in the cleaner 4 by the cleaning blade 41.

After the sheet is sent into the fixing device 111 and receives heat and pressure to make the transferred image fixed, it is stacked on a discharging tray 116 by a pair of discharging rollers 115.

Alternatively, the sheet is conveyed into a sheet reversing device 112 by switching the transfer path by a switching claw, reversed and guided to the transfer point again followed by image recording at the other side of the sheet, and discharged into the discharging tray 116 by the pair of discharging rollers 115.

The intermediate transfer belt 105 is cleaned by the intermediate transfer element cleaner 109 after transfer of the image to be ready for the next image forming by the tandem the image forming unit 10.

As described above, an image forming apparatus having multiple development devices is used but it is not necessarily employ “the tandem type intermediate transfer system” in which multiple toner images having different colors sequentially produced by the multiple development devices are temporarily sequentially transferred onto a transfer medium once such as paper by way of an intermediate transfer medium followed by fixing. It is also possible to employ “the tandem type direct transfer system” in which thus-produced multiple images are sequentially superimposed on a transfer medium followed by fixing.

It is preferable to arrange a charger in contact with or the proximity of the surface of the drum photoreceptor because the amount of ozone produced during charging is markedly reduced in comparison with a corona discharger using a discharging wire such as corotron or scorotron.

However, in such a charger that charges the image bearing member by contact or in the proximity thereof, since discharging is conducted in the area close to the surface of the image bearing member as described above, the electric stress on the image bearing member tends to increase. By using the image forming method of the embodiment, protective agents are stably supplied over a long period of time to maintain the image bearing member without degradation.

As a consequence, variance of the image quality can be reduced over a long period of time irrespective of usage environment, so that the image quality is stably secured.

As described above, in this embodiment, the particulates having true spherical form present away from the toner are preliminarily mixed and the mixture is supplied to the development agent accommodating unit of the development unit 5.

The particulates having true spherical form are supplied to the surface of the drum photoreceptor 1 by the development roller 51 and exist between the surface of the drum photoreceptor 1 and the surface of the foam roller 22 as the elastic roller to reduce the mechanical stress.

In this embodiment, the particulates having true spherical form are supplied by using the development unit but the supplying method is not limited thereto. It is also suitable to provide a device to supply the particulates having true spherical form separately.

Also, the particulates having true spherical form is possibly supplied from the foam roller 22.

By using the development device, there is no need to supply the particulates having true spherical form without providing any new separate device, meaning that a simple device suffices in this embodiment.

In the case in which the protective agent contains an aliphatic acid metal salt and an inorganic lubricant, wear of the image bearing member, contamination on the image bearing member, and contamination on the charging roller are reduced.

When the aliphatic acid metal salt contains zinc stearate as a main component, zinc stearate suitably protects the image bearing member, thereby particularly reducing wear and contamination of the image bearing member.

When the inorganic lubricant is boron nitride, contamination of the charging roller is particularly reduced due to the good lubricity of boron nitride.

In addition, by supplying the particulates having true spherical form, the members around the image bearing member have longer serving life and the mechanical stress of the devices is reduced.

### Examples for First Embodiment

### Manufacturing Example of Protective Agent

The compositions of the protective agent prescriptions shown in Table 1 were mixed according to the mixing ratio (based on weight) in Table 1. The compositions were mixed twice at 25,000 rotation per minute (rpm) for 10 seconds using Wonder Blender (WB-1, available from OSAKA CHEMICAL Co., Ltd.) to obtain a sample powder mixture.

Next, the compositions of the protective agents 1 to 4 were placed in an aluminum mold with a depth of 20 mm, a width of 8 mm, and a length of 350 mm and the surface was smoothed by a spurtle.

Thereafter, the compositions were compressed under pressure by a press in order to obtain a compaction powder having a height of 8 mm. The mass of the powder put into the mold was adjusted to make the filling ratio of the compaction powder 90%. That is, the mass of the powder put into the mold was equal to the volume of the mold×true specific gravity×0.9.

After molding, the solid content was taken out from the mold, shaped to have a dimension of 8 mm×8 mm×320 mm, and attached to a metal support by a double-stick tape to manufacture protective agents 1 to 4.

TABLE 1

| | Aliphatic acid | Parts | Inorganic | |
|---|---|---|---|---|
| | metal salt | by weight | lubricant | Parts by weight |
| Protective | Zinc stearate | 80 | Boron nitride | 20 |
| Agent 1 | | | | |
| Protective | Zinc stearate | 100 | None | 0 |
| Agent 2 | | | | |
| Protective | Zinc laurate | 80 | Boron nitride | 20 |
| Agent 3 | | | | |
| Protective | Zinc stearate | 80 | Mica | 20 |
| Agent 4 | | | | |

### Example 1

The image bearing member unit was taken out from the black station of an image forming apparatus (color MFP imagio MP C5000, manufactured by Ricoh Co., Ltd.) including a protective agent application unit and a protective agent 1 was used as the protective agent.

Furthermore, instead of the brush roller serving as the protective agent applicator, a foam roller having a continuous air bubble type polyurethane layer having 70 cells/inch and a hardness of 150N was attached.

The core metal of the urethane roller was the same as that of the brush roller and the thickness of the foam urethane layer was adjusted such that the outer diameter of the foam roller is the same as the outer diameter of the brush roller.

Next, the development agent was taken out from the black development unit of imagio MP C5000 and the particulates having true spherical form shown in Table 1 were added in a weight ratio of 0.15% to the mass of the toner followed by five-minute stirring by a turbula mixer. Thereafter, the thus-obtained development agent was returned to the development unit.

Furthermore, the toner was taken out of the black toner bottle for imagio MP C5000 and the particulates having true spherical form shown in Table 1 were added in a weight ratio of 0.15% to the mass of the toner followed by five-minute stirring by a turbula mixer. Thereafter, the thus-obtained toner was returned to the black toner bottle to serve as replenishing toner.

The particulates having true spherical form were preliminarily sufficiently stirred by a mixer to reduce agglomeration.

The thus-obtained image bearing member unit and the thus-obtained development unit and the replenishing toner were installed onto the black station of imagio MP C5000.

### Evaluation

Using the imagio MP C5000 remodeled as described above, a chart having an image area ratio of 5% was continuously printed on 10 A4 sheets. The average of the load current applied to the image bearing member driving motor was measured and it was compared with the reference load current of imagio MP C5000 in the standard state (in which brush roller was used as the protective agent applicator) by showing how many times the measured value was as large as the reference load current.

Then, the same chart was continuously printed with a run length of 60,000 and the consumption amount of the image bearing member was measured for the traveling distances of the initial 1,000 prints and the last 1,000 prints (59,001st to 60,000th sheet). Furthermore, the contamination level of the image bearing member and the charger at the end of the run was observed with naked eyes.

If any defect was observed, whether a defective image was produced at the portion corresponding to the defect was confirmed.

Since the protective agent applicator was driven by the image bearing member driving motor by way of a driving gear in imagio MP C5000, as the force to drive the protective agent applicator increased, the load applied to the image bearing member driving motor increased so that a larger current was detected.

In addition, imagio MP C5000 adopts the technology disclosed in JP-2007-293240-A at the mechanism to press the protective agent so that the pressure was significantly constant over time. The mechanism of pressing the protective agent does not affect the change in the consumption amount of the protective agent caused by a machine run.

### Examples 2 to 11

Examples 2 to 11 were conducted and evaluated in the same manlier as in Example 1 except that the protective agent, the particulates having true spherical form added to the development agent and the toner, and the addition amount of the particulates were changed as shown in Table 2.

TABLE 2

| | | Particulates Added To Development | | | |
|---|---|---|---|---|---|
| | | Agent and Toner | | | |
| | | | | | Addition |
| | | | | | amount |
| | | | Particle | | (percent |
| | Protective | | Diameter | | based on |
| | Agent | Material | (μm) | Sphericity | toner) |
| Example 1 | Protective | Silica | 0.12 | 0.88 | 0.15 |
| | Agent 1 | | | | |
| Example 2 | Protective | Silica | 0.49 | 0.86 | 0.15 |
| | Agent 1 | | | | |
| Example 3 | Protective | Alumina | 0.31 | 0.92 | 0.15 |
| | Agent 1 | | | | |
| Example 4 | Protective | Alumina | 0.72 | 0.92 | 0.15 |
| | Agent 1 | | | | |
| Example 5 | Protective | Alumina | 3.0 | 0.94 | 0.20 |
| | Agent 1 | | | | |
| Example 6 | Protective | Silicone | 0.50 | 0.93 | 0.25 |
| | Agent 1 | Resin | | | |
| Example 7 | Protective | Silicone | 3.0 | 0.95 | 0.30 |
| | Agent 1 | Resin | | | |
| Example 8 | Protective | Silicone | 4.5 | 0.95 | 0.30 |
| | Agent 1 | Resin | | | |
| Example 9 | Protective | Silicone | 0.72 | 0.92 | 0.15 |
| | Agent 2 | Resin | | | |
| Example 10 | Protective | Alumina | 0.72 | 0.92 | 0.15 |
| | Agent 3 | | | | |
| Example 11 | Protective | Alumina | 0.72 | 0.92 | 0.15 |
| | Agent 4 | | | | |
| Example 12 | Protective | Alumina | 0.31 | 0.92 | 0.15 |
| | Agent 1 | | | | |
| Example 13 | Protective | Alumina | 0.72 | 0.92 | 0.15 |
| | Agent 1 | | | | |
| Example 14 | Protective | Alumina | 3.0 | 0.90 | 0.15 |
| | Agent 1 | | | | |
| Example 15 | Protective | Alumina | 0.31 | 0.92 | 0.15 |
| | Agent 1 | | | | |
| Example 16 | Protective | Alumina | 0.72 | 0.92 | 0.15 |
| | Agent 1 | | | | |
| Example 17 | Protective | Alumina | 3.0 | 0.90 | 0.15 |
| | Agent 1 | | | | |
| Comparative | Protective | None | — | — | — |
| Example 1 | Agent 1 | | | | |
| Comparative | Protective | None | — | — | — |
| Example 2 | Agent 1 | | | | |
| Comparative | Protective | None | — | — | — |
| Example 3 | Agent 1 | | | | |
| Comparative | Protective | Alumina | 0.50 | 0.67 | 0.15 |
| Example 4 | Agent 1 | | | | |
| Comparative | Protective | Alumina | 0.72 | 0.92 | 0.15 |
| Example 5 | Agent 1 | | | | |
| Comparative | Protective | None | — | — | — |
| Example 6 | Agent 1 | | | | |

### Examples 12 to 14

Examples 12 to 14 were conducted and evaluated in the same manner as in Examples 3 to 5 except that a foam roller having a continuous air bubble type polyurethane layer having 50 cells/inch and a hardness of 270N was used instead.

### Examples 15 to 17

Examples 15 to 17 were conducted and evaluated in the same manner as in Examples 3 to 5 except that a foam roller having a continuous air bubble type polyurethane layer having 175 cells/inch and a hardness of 360N was used instead.

### Comparative Example 1

Comparative Example 1 was conducted and evaluated in the same manner as in Example 4 except that no particulates having true spherical form were added to the development agent or the toner.

### Comparative Example 2

Comparative Example 2 was conducted and evaluated in the same manner as in Example 13 except that no particulates having true spherical form were added to the development agent or the toner.

### Comparative Example 3

Comparative Example 3 was conducted and evaluated in the same manner as in Example 16 except that no particulates having true spherical form were added to the development agent or the toner.

### Comparative Example 4

Comparative Example 4 was conducted and evaluated in the same manner as in Example 4 except that alumina having an irregular form (particle diameter: 0.5 μm, sphericity: 0.67) was added to the development agent and the toner.

### Comparative Example 5

Comparative Example 5 was conducted and evaluated in the same manner as in Example 4 except that the brush roller installed on imagio MP C5000 as the protective agent applicator was used as it was.

### Comparative Example 6

Comparative Example 6 was conducted and evaluated in the same manner as in Comparative Example 5 except that no particulates having true spherical form were added to the development agent or the toner.

The results of Examples 1 to 17 and Comparative Examples 1 to 6 are shown in Table 3.

TABLE 3

| | Relative | | | | | |
|---|---|---|---|---|---|---|
| | Value of | | | | | |
| | Load | | | | | |
| | Current of | | | | | |
| | Image | Consumption | | | | |
| | Bearing | Amount of | | | | |
| | Member | Protective | | Wear | | |
| | Driving | Agent | | Amount | Contamination | |
| | Motor | per 1,000 | | of Image | Level | |
| | (times | sheets | | Bearing | After Run | |
| | based on | (g/km) | | Member | Image | |
| | standard | | After | After Run | Bearing | Charging |
| | state) | Initial | Run | (μm) | Member | Roller |
| Example 1 | 1.4 | 0.17 | 0.15 | 0.28 | E | E |
| Example 2 | 1.1 | 0.18 | 0.15 | 0.31 | E | E |
| Example 3 | 1.1 | 0.17 | 0.16 | 0.31 | E | E |
| Example 4 | 1.0 | 0.17 | 0.15 | 0.30 | E | E |
| Example 5 | 1.0 | 0.16 | 0.15 | 0.31 | E | E |
| Example 6 | 1.1 | 0.18 | 0.16 | 0.25 | E | E |
| Example 7 | 1.0 | 0.17 | 0.14 | 0.24 | E | E |
| Example 8 | 1.0 | 0.17 | 0.15 | 0.35 | F | E |
| Example 9 | 1.0 | 0.19 | 0.16 | 0.30 | E | F |
| Example 10 | 1.0 | 0.18 | 0.15 | 0.31 | F | G |
| Example 11 | 1.0 | 0.18 | 0.15 | 0.33 | G | G |
| Example 12 | 1.0 | 0.19 | 0.17 | 0.31 | E | E |
| Example 13 | 1.0 | 0.16 | 0.15 | 0.30 | E | E |
| Example 14 | 1.0 | 0.18 | 0.15 | 0.28 | G | E |
| Example 15 | 1.2 | 0.18 | 0.14 | 0.30 | E | E |
| Example 16 | 1.0 | 0.17 | 0.15 | 0.28 | E | E |
| Example 17 | 1.1 | 0.18 | 0.16 | 0.30 | E | E |
| Comparative | 2.5 | 0.18 | 0.15 | 0.25 | E | E |
| Example 1 | | | | | | |
| Comparative | 2.4 | 0.19 | 0.16 | 0.25 | E | E |
| Example 2 | | | | | | |
| Comparative | 3.1 | 0.18 | 0.15 | 0.27 | E | E |
| Example 3 | | | | | | |
| Comparative | 2.3 | 0.17 | 0.15 | 0.72 | B | E |
| Example 4 | | | | | | |
| Comparative | 1.0 | 0.87 | 0.08 | 0.41 | B | E |
| Example 5 | | | | | | |
| Comparative | 1.0 | 0.88 | 0.10 | 0.35 | B | E |
| Example 6 | | | | | | |

E (Excellent): No contamination
G (Good): Contaminated but not appear on image
F (Fair): Contaminated and appear on image at affordable level
B (Bad): Contaminated causing problems on image

As seen in Table 3, in Examples 1 to 17, the mechanical stress to drive the protective agent applicator was small and the consumption amount of the protective agent was stable over time.

Furthermore, as seen in the evaluation results, the wear amount of the image bearing member, the contamination of the image bearing member, and the contamination of the charging roller were reduced, thereby keeping the print quality good for an extended period of time.

In comparison between Examples 1 and 8 and the other Examples, it is found that by adjusting the average particle diameter of the particulates having true spherical form for use in the embodiment in a range of from 0.3 μm to 3.0 μm, the mechanical stress was particularly reduced and the contamination level of the image bearing member decreased.

As seen in comparison between Examples 4 and 9, when the aliphatic acid metal salt and the inorganic lubricant were contained in the protective agent, all of the wear of the image bearing member, the contamination level of the image bearing member, and the contamination level of the charging roller was markedly lowered.

As seen in comparison between Examples 4, 10, and 11, excellent results were obtained by using zinc stearate as the aliphatic acid metal salt and boron nitride as the inorganic lubricant.

In Comparative Examples 1 to 3, the mechanical stress during driving was extremely large because a foam roller was used as the protective agent applicator and no particulates having true spherical form were added.

In Comparative Example 4, since the particulates having an irregular form were added, the mechanical stress was little reduced and the wear amount of the image bearing member and the contamination level were high.

In Comparative Examples 5 and 6, since a brush was used as the protective agent applicator, the mechanical stress was small irrespective of whether the particulates having true spherical form were added or not but the initial consumption amount of the protective agent was extremely large and the consumption amount was reduced after a run, which made it difficult to produce quality images stable for an extended period of time.

The second embodiment is described next.

While the particulates having true spherical form are supplied from the development device in the first embodiment, the particulates having true spherical form supplied are contained in the protective agent in the second embodiment.

### Examples for Second Embodiment

### Manufacturing Example of Protective Agent

The compositions of the protective agents 1 to 13 shown in Table 4 were mixed with the mixing ratio (based on weight) shown in Table 4. The average particle diameter and the average sphericity of the particulates having true spherical form used are shown in Table 5.

The compositions were mixed twice at 25,000 rotation per minute (rpm) for 10 seconds using Wonder Blender (WB-1, available from OSAKA CHEMICAL Co., Ltd.) to obtain a sample powder mixture.

Next, the compositions of the protective agents 1 to 13 were placed in an aluminum die with a depth of 20 mm, a width of 8 mm, and a length of 350 mm and the surface was smoothed by a spurtle. Thereafter, the compositions were compressed under pressure by a press in order to obtain a compaction powder having a height of 8 mm. The mass of the powder put into the mold was adjusted to make the filling ratio of the compaction powder 90%. That is, the mass of the powder put into the mold was equal to the volume of the mold×true specific gravity×0.9.

After molding, the solid content was taken out from the mold, shaped to have a dimension of 8 mm×8 mm×320 mm, and attached to a meal support by a double-stick tape to manufacture protective agents 1 to 13.

TABLE 4

| | | | | | Particulate | |
|---|---|---|---|---|---|---|
| | Aliphatic | | | Parts | having true | |
| | acid metal | Parts by | Inorganic | by | spherical | Parts |
| | salt | weight | lubricant | weight | form | by weight |
| Protective | Zinc | 80 | Boron | 20 | Silica A | 10 |
| Agent 1 | stearate | | nitride | | | |
| Protective | Zinc | 80 | Boron | 20 | Silica B | 10 |
| Agent 2 | stearate | | nitride | | | |
| Protective | Zinc laurate | 80 | Boron | 20 | Alumina A | 5 |
| Agent 3 | | | nitride | | | |
| Protective | Zinc | 80 | Boron | 20 | Alumina B | 5 |
| Agent 4 | stearate | | nitride | | | |
| Protective | Zinc | 80 | Boron | 20 | Alumina C | 5 |
| Agent 5 | stearate | | nitride | | | |
| Protective | Zinc | 80 | Boron | 20 | Silicone resin A | 10 |
| Agent 6 | stearate | | nitride | | | |
| Protective | Zinc laurate | 80 | Boron | 20 | Silicone resin B | 5 |
| Agent 7 | | | nitride | | | |
| Protective | Zinc | 80 | Boron | 20 | Silicone resin C | 5 |
| Agent 8 | stearate | | nitride | | | |
| Protective | Zinc | 100 | None | — | Alumina B | 5 |
| Agent 9 | stearate | | | | | |
| Protective | Zinc laurate | 80 | Boron | 20 | Alumina B | 5 |
| Agent 10 | | | nitride | | | |
| Protective | Zinc | 80 | Mica | 20 | Alumina B | 5 |
| Agent 11 | stearate | | | | | |
| Protective | Zinc laurate | 80 | Boron | 20 | None | — |
| Agent 12 | | | nitride | | | |
| Protective | Zinc | 80 | Boron | 20 | Alumina D | 5 |
| Agent 13 | stearate | | nitride | | | |

TABLE 5
Particulate having true spherical form used

| | Average particle | Average | |
|---|---|---|---|
| Material | diameter (μm) | sphericity | |
| Silica A | 0.12 | 0.88 | |
| Silica B | 0.49 | 0.86 | |
| Alumina A | 0.31 | 0.92 | |
| Alumina B | 0.72 | 0.90 | |
| Alumina C | 3.0 | 0.94 | |
| Alumina D | 0.50 | 0.67 | Not true spherical |
| | | | form |
| Silicone resin A | 0.50 | 0.93 | |
| Silicone resin B | 3.0 | 0.95 | |
| Silicone resin C | 4.5 | 0.95 | |

### Example 1

The image bearing member unit was taken out from the black station of an image forming apparatus (color MFP imagio MP C5000, manufactured by Ricoh Co., Ltd.) including a protective agent application unit and a protective agent 1 was used as the protective agent. Furthermore, instead of the brush roller serving as the protective agent applicator, a foam roller having a continuous air bubble type polyurethane layer having 70 cells/inch and a hardness of 150N was attached. The core metal of the urethane roller was the same as that of the brush roller and the thickness of the foam urethane layer was adjusted such that the outer diameter of the foam roller is the same as the outer diameter of the brush roller.

The thus-obtained image bearing member unit was installed onto the black station of imagio MP C5000.

### Evaluation

Using the imagio MP C5000 remodeled as described above, a chart having an image area ratio of 5% was continuously printed on 10 A4 sheets.

The average of the load current applied to the image bearing member driving motor was measured and it was compared with the reference load current of imagio MP C5000 in the standard state (in which brush roller was used as the protective agent applicator) by showing how many times the measured value was as large as the reference load current. Then, the same chart was continuously printed with a run length of 60,000 and the consumption amount of the image bearing member was measured for the traveling distances of the initial 1,000 prints and the last 1,000 prints (59,001st to 60,000th sheet).

The layer thickness of the image bearing member was measured after the run to obtain the wear amount from the initial.

The layer thickness was measured by an eddy-current film thickness meter (Fischer scope MMs, manufactured by Fischer Instruments K.K.) and the average was calculated for 20 points selected with each having a gap of 10 mm excluding the both ends. Furthermore, the contamination level of the surface of the image bearing member and the charger was observed with naked eyes. If any defect was observed, whether a defective image was produced at the portion corresponding to the defect was confirmed.

Since the protective agent applicator was driven by the image bearing member driving motor by way of a driving gear in imagio MP C5000, as the force to drive the protective agent applicator increased, the load applied to the image bearing member driving motor increased so that a larger current was detected.

In addition, imagio MP C5000 adopts the technology disclosed in JP-2007-293240-A at the mechanism to press the protective agent so that the pressure was significantly constant over time.

The mechanism of pressing the protective agent does not affect the change in the consumption amount of the protective agent caused by a machine run.

### Examples 2 to 11

Examples 2 to 11 were conducted and evaluated in the same manner as in Example 1 except that the protective agents 2 to 11 were used instead of the protective agent 1.

### Examples 12 to 14

Examples 12 to 14 were conducted and evaluated in the same manner as in Examples 3 to 5 except that a foam roller having a continuous air bubble type polyurethane layer having 50 cells/inch and a hardness of 270N was used instead.

### Examples 15 to 17

Examples 15 to 17 were conducted and evaluated in the same manner as in Examples 3 to 5 except that a foam roller having a continuous air bubble type polyurethane layer having 175 cells/inch and a hardness of 360N was used instead.

### Comparative Example 1

Comparative Example 1 was conducted and evaluated in the same manner as in Example 1 except that the protective agent 12 was used instead of the protective agent 1.

### Comparative Example 2

Comparative Example 2 was conducted and evaluated in the same manner as in Example 12 except that the protective agent 12 was used instead of the protective agent 3.

### Comparative Example 3

Comparative Example 3 was conducted and evaluated in the same manner as in Example 15 except that the protective agent 12 was used instead of the protective agent 3.

### Comparative Example 4

Comparative Example 4 was conducted and evaluated in the same manner as in Example 1 except that the protective agent 13 was used instead of the protective agent 1.

### Comparative Example 5

Comparative Example 5 was conducted and evaluated in the same manner as in Example 4 except that the brush roller installed on imagio MP C5000 as the protective agent applicator was used as it was.

### Comparative Example 6

Comparative Example 6 was conducted and evaluated in the same manner as in Comparative Example 5 except that the protective agent 12 was used instead of the protective agent 4.

The measuring results and observation results of Examples 1 to 17 and Comparative Examples 1 to 6 are shown in Table 6.

TABLE 6

| | Relative | | | | | |
|---|---|---|---|---|---|---|
| | Value of | | | | | |
| | Load | | | | | |
| | Current of | | | | | |
| | Image | Consumption | | | | |
| | Bearing | Amount of | | | | |
| | Member | Protective | | Wear | | |
| | Driving | Agent | | Amount | Contamination | |
| | Motor | per 1,000 | | of Image | Level | |
| | (times | sheets | | Bearing | After Run | |
| | based on | (g/km) | | Member | Image | |
| | standard | | After | After Run | Bearing | Charging |
| | state) | Initial | Run | (μm) | Member | Roller |
| Example 1 | 1.4 | 0.17 | 0.15 | 0.28 | E | E |
| Example 2 | 1.0 | 0.17 | 0.15 | 0.33 | E | E |
| Example 3 | 1.0 | 0.17 | 0.16 | 0.30 | E | E |
| Example 4 | 1.0 | 0.17 | 0.15 | 0.30 | E | E |
| Example 5 | 1.1 | 0.17 | 0.15 | 0.32 | E | E |
| Example 6 | 1.1 | 0.18 | 0.16 | 0.27 | E | E |
| Example 7 | 1.0 | 0.17 | 0.15 | 0.28 | E | E |
| Example 8 | 1.0 | 0.18 | 0.15 | 0.36 | F | E |
| Example 9 | 1.0 | 0.19 | 0.16 | 0.30 | E | F |
| Example 10 | 1.1 | 0.19 | 0.16 | 0.33 | F | G |
| Example 11 | 1.0 | 0.18 | 0.16 | 0.30 | G | G |
| Example 12 | 1.0 | 0.19 | 0.17 | 0.31 | E | E |
| Example 13 | 1.0 | 0.18 | 0.16 | 0.31 | E | E |
| Example 14 | 1.0 | 0.18 | 0.15 | 0.28 | G | E |
| Example 15 | 1.2 | 0.18 | 0.15 | 0.32 | E | E |
| Example 16 | 1.1 | 0.18 | 0.15 | 0.30 | E | E |
| Example 17 | 1.1 | 0.18 | 0.16 | 0.30 | E | E |
| Comparative | 2.5 | 0.18 | 0.15 | 0.25 | E | E |
| Example 1 | | | | | | |
| Comparative | 2.4 | 0.19 | 0.16 | 0.25 | E | E |
| Example 2 | | | | | | |
| Comparative | 3.1 | 0.18 | 0.15 | 0.27 | E | E |
| Example 3 | | | | | | |
| Comparative | 2.3 | 0.17 | 0.15 | 0.72 | B | E |
| Example 4 | | | | | | |
| Comparative | 1.0 | 0.87 | 0.08 | 0.41 | B | E |
| Example 5 | | | | | | |
| Comparative | 1.0 | 0.88 | 0.10 | 0.35 | B | E |
| Example 6 | | | | | | |

E (Excellent): No contamination
G (Good): Contaminated but not appear on image
F (Fair): Contaminated and appear on image at affordable level
B (Bad): Contaminated causing problems on image

As seen in Table 6, in Examples 1 to 17, the mechanical stress to drive the protective agent applicator was small and the consumption amount of the protective agent was stable over time.

Furthermore, as seen in the evaluation results, the wear amount of the image bearing member, the contamination of the image bearing member, and the contamination of the charging roller were reduced, thereby keeping the print quality good for an extended period of time.

In comparison between Examples 1 and 8 and the other Examples, it is found that by adjusting the average particle diameter of the particulates having true spherical form for use in the embodiment in a range of from 0.3 μm to 3.0 μm, the mechanical stress was particularly reduced and the contamination level of the image bearing member decreased.

That is, in Example 1, since the average particle diameter of the particulates having true spherical form was 0.12 (<0.3) μm, the load current relative value was 1.4 (which was large). In addition, in Example 8, since the average particle diameter of the particulates having true spherical form was 4.5 (>0.3) μm, the image bearing member was not free from contamination.

As seen in comparison between Examples 4 and 9, when the aliphatic acid metal salt and the inorganic lubricant were contained in the protective agent, all of the wear of the image bearing member, the contamination level of the image bearing member, and the contamination level of the charging roller was markedly lowered.

As seen in comparison between Examples 4, 10, and 11, excellent results were obtained by using zinc stearate as the aliphatic acid metal salt and boron nitride as the inorganic lubricant.

In Comparative Examples 1 to 3, the mechanical stress during driving was extremely large because a foam roller was used as the protective agent applicator and no particulates having true spherical form were added.

In Comparative Example 4, since the particulates having an irregular form were added, the mechanical stress was little reduced and the wear amount of the image bearing member and the contamination level were high.

In Comparative Examples 5 and 6, since a brush was used as the protective agent applicator, the mechanical stress was small irrespective of whether the particulates having true spherical form were added or not but the initial consumption amount of the protective agent was extremely large and the consumption amount was reduced after a run, which made it difficult to produce quality images stable for an extended period of time.

As shown above, by using a foam roller, the consumption amount of a protective agent over time is stabilized and by supplying particulates having a true spherical form between the image bearing member and the foam roller, the mechanical stress to drive the foam roller is reduced, thereby keeping the print quality good for an extended period of time.

Having now fully described embodiments of the present invention, it will be apparent to one of ordinary skill in the art that many changes and modifications can be made thereto without departing from the spirit and scope of embodiments of the invention as set forth herein.

What is claimed is:

1. An image forming method comprising:
forming a latent electrostatic image borne on an image bearing member;
developing the latent electrostatic image with a development agent comprising toner and accommodated in a development unit;
applying a protective agent to a surface of the image bearing member by a protective agent supplying device comprising a foam roller; and
supplying particulates having a true spherical form between the surface of the image bearing member and a surface of the foam roller.

2. The image forming method according to claim 1, wherein the particulates having a true spherical form have an average particle diameter of from 0.3 μm to 3.0 μm.

3. The image forming method according to claim 1, wherein the particulates having a true spherical form are contained in the development agent and supplied to the surface of the image bearing member by the development unit.

4. The image forming method according to claim 3, further comprising preliminarily mixing the particulates having a true spherical form with the toner and supplying the particulates to the development agent.

5. The image forming method according to claim 1, wherein the particulates having a true spherical form are contained in the protective agent and supplied to the surface of the image bearing member together with the protective agent.

6. The image forming method according to claim 1, wherein the protective agent is a block of compression-molded granular material comprising:
an aliphatic acid metal salt;
an inorganic lubricant; and
optionally the particulates having a true spherical form.

7. The image forming method according to claim 6, wherein the aliphatic acid metal salt includes zinc stearate.

8. The image forming method according to claim 6, wherein the inorganic lubricant is boron nitride.

9. An image forming apparatus comprising:
an image bearing member to bear a latent electrostatic image thereon;
a development unit to develop the latent electrostatic image with a development agent comprising toner;
a protective agent supplying device comprising a foam roller to apply or attach a protective agent to the surface of the image bearing member; and
a cleaner to clean the surface of the image bearing member,
wherein the image forming apparatus executes the image forming method of claim 1.

10. A process cartridge comprising:
an image bearing member to bear a latent electrostatic image thereon;
a development unit to develop the latent electrostatic image with a development agent comprising toner; and
a protective agent supplying device comprising a foam roller to apply or attach a protective agent to the surface of the image bearing member,
wherein the process cartridge executes the image forming method of claim 1 and is detachably attachable to an image forming apparatus.
